(19) United States
(12) Patent Application Publication
(10) Pub. No.: US 2011/0115808 A1
(43) Pub. Date: May 19, 2011

(54) DISPLAY APPARATUS AND METHOD OF ADJUSTING IMAGE QUALITY THEREOF

(75) Inventor: Gyo-hwan GOO, Hwaseong-si (KR)

(73) Assignee: SAMSUNG ELECTRONICS CO., LTD., Suwon-si (KR)

(21) Appl. No.: 12/946,973

(22) Filed: Nov. 16, 2010

(30) Foreign Application Priority Data
Nov. 16, 2009 (KR) 10-2009-0110409

(51) Int. Cl. G09G 5/02; G09G 5/00

(52) U.S. Cl. 345/589; 345/581

(57) ABSTRACT

A display apparatus and a method of adjusting image quality of a display apparatus which displays an image on the basis of an image signal are provided. The display apparatus includes a signal processor that processes an image signal; a display unit that displays an image based on the image signal processed by the signal processor; a storage unit that stores a measured value representing image quality of the display unit; and an image quality adjustment unit that carries out image quality adjustment of the display unit based on the measured value and a preset target value corresponding to a desired image quality of the display unit.

### CROSS-REFERENCE TO RELATED APPLICATION

This application claims priority from Korean Patent Application No. 10-2009-0110409, filed on Nov. 16, 2009 in the Korean Intellectual Property Office, the disclosure of which is herein incorporated by reference.

### BACKGROUND

1. Field

Apparatuses and methods consistent with exemplary embodiments relate to a display apparatus and a method of adjusting image quality thereof, and more particularly to a display apparatus which quickly and easily adjusts image quality and a method of adjusting image quality thereof.

2. Description of the Related Art

A display apparatus, such as a TV, monitor, mobile phone, PDA and a navigation system, displays images using a display device, such as an LCD. Each of the display devices which are manufactured can be different in performance, and thus the image quality adjustment of the display apparatus is performed to make the image quality for all of the display devices more uniform.

The image quality adjustment of the display apparatus may be carried out during manufacturing or repairing of the display apparatus. According to an image quality adjustment method of the related art, the image quality of a display apparatus is measured and an adjustment factor of the display apparatus is adjusted until the measured image quality reaches a target image quality.

However, there are some difficulties in measuring the image quality for the image quality adjustment. First, in order to obtain proper measured results for the image quality adjustment, a display device to be measured needs to be sufficiently aged. The aging of a display device takes a substantial amount of time, and thus the manufacturing process of the display device may be extended undesirably, particularly when the image quality adjustment is carried out during the manufacturing process.

Furthermore, a measurement device for the image quality adjustment is required to obtain the measurement results, but it is not easy to prepare the measurement device when the image quality adjustment is carried out during repair of the display device in after-sales service.

### SUMMARY

According to an aspect of the exemplary embodiments, a display apparatus is provided which includes a signal processor that processes an image signal; a display unit that displays an image based on the image signal processed by the signal processor; a storage unit that stores a measured value representing image quality of the display unit; and an image quality adjustment unit that carries out image quality adjustment of the display unit on the basis of the measured value stored in the storage unit and a preset target value corresponding to a desired image quality of the display unit.

The storage unit may be provided in the display unit.

The display unit may include a display panel that displays the image and a panel driving circuit that drives the display panel on the basis of the image signal.

The display apparatus may further include a main circuit board, wherein the image quality adjustment unit may include a CPU, which is provided in the main circuit board and executes a program to carry out the image quality adjustment of the display unit.

The image quality adjustment of the display unit may include at least one of color adjustment and brightness adjustment of the image displayed by the display unit.

The display apparatus may further include a signal receiver that receives the image signal, wherein the image signal may include a broadcasting signal.

According to another aspect of the exemplary embodiments, there is provided a method of adjusting image quality of a display apparatus which displays an image on the basis of an image signal, the method including reading out a measured value representing image quality from a storage unit of the display apparatus; and carrying out image quality adjustment of the display apparatus on the basis of the measured value and a preset target value corresponding to a desired image quality of the display apparatus.

The display apparatus may include a display panel that displays an image and a panel driving circuit that drives the display panel on the basis of the image signal.

The display apparatus may further include a main circuit board on which a CPU is provided, and carrying out the image quality adjustment comprises executing a program using the CPU.

Carrying out the image quality adjustment of the display apparatus may include adjusting at least one of color and brightness of the image displayed by the display apparatus.

The image signal may include a broadcasting signal.

According to another aspect of the exemplary embodiments, there is provided a process of adjusting image quality during assembly of a display apparatus, the process including providing a display unit comprising a display panel and a storage unit; measuring a value corresponding to the image quality of the display panel; storing the measured value in the storage unit of the display unit; combining the display unit with a main circuit board comprising a memory storing an image quality adjustment program; and performing adjustment of the image quality based on the measured value stored in the storage unit of the display unit using the image quality adjustment program.

The memory on the main circuit board may store a target value, and the image quality adjustment program may adjust the image quality based on the measured value and the target value.

The memory may comprise a register which stores an adjustment factor for the image quality, and the image quality adjustment program may adjust the adjustment factor based on the measured value and the target value.

Providing the display unit may comprise manufacturing the display unit.

Providing the display unit may comprise receiving a display unit for servicing.

The measured value of the image quality may be stored in the storage unit at a preset address, and the image quality adjustment program may access the preset address to read out the measured value.

The image quality adjustment program may be preprogrammed with the preset address of the storage unit from which to read the measured value.

According to another aspect of the exemplary embodiments, there is provided a process for adjusting image quality of a display apparatus during manufacturing is provided, the process comprising manufacturing a display panel comprising a storage; measuring a value corresponding to the image quality of the display panel; storing the measured value in the storage; separately manufacturing a main circuit board comprising a controller storing an image quality adjustment program; assembling the display panel and the main circuit board together into the display apparatus; and adjusting the image quality of the display panel based on the measured value stored in the storage using the image quality adjustment program.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of a display apparatus according to an exemplary embodiment;

FIG. 2 is a flow chart illustrating a whole process of adjusting image quality by the display apparatus of FIG. 1;

FIG. 3 is a flow chart illustrating a process of adjusting image quality by the display apparatus of FIG. 1; and

FIG. 4 is a color coordinate used for image quality adjustment by the display apparatus of FIG. 1.

### DETAILED DESCRIPTION

Below, exemplary embodiments will be described in detail with reference to accompanying drawings so as to be easily realized by a person having ordinary knowledge in the art. The present invention may be embodied in various forms without being limited to the exemplary embodiments set forth herein. Descriptions of well-known parts are omitted for clarity, and like reference numerals refer to like elements throughout. Also, expressions such as “at least one of” when preceding a list of elements modify the entire list of elements and do not modify the individual elements of the list.

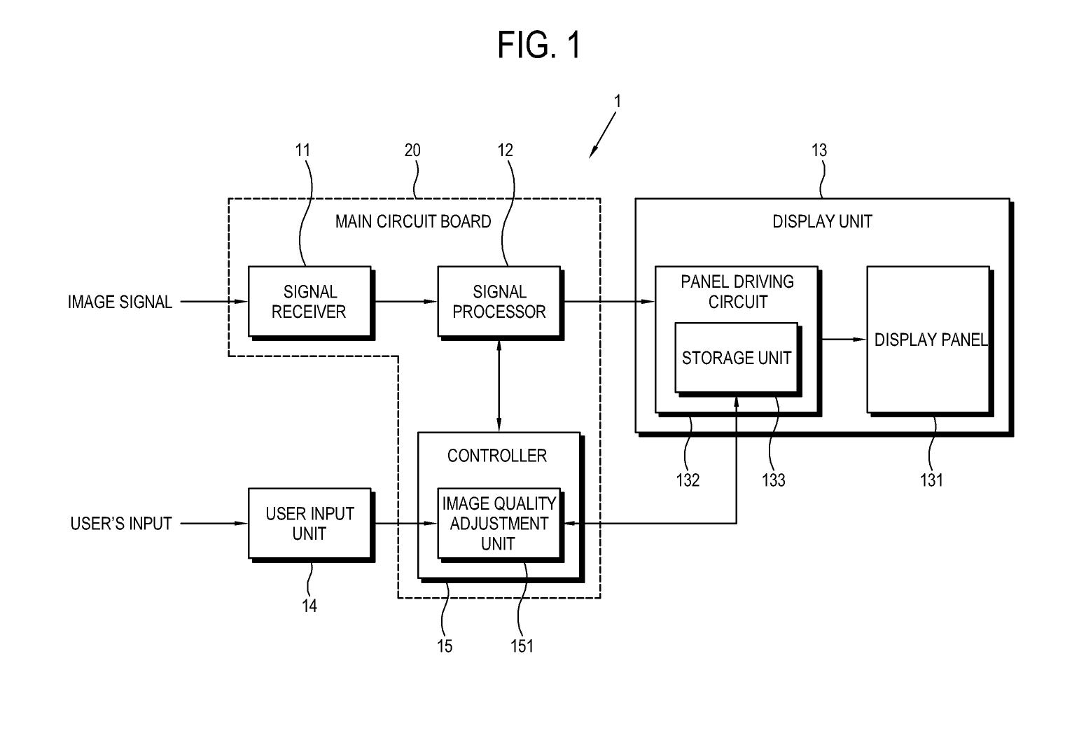

FIG. 1 is a block diagram illustrating a configuration of a display apparatus 1 according to an exemplary embodiment. The display apparatus 1 of FIG. 1 may be realized by a TV. However, the display apparatus is not limited thereto, but may be realized by various devices with a display unit, such as a PC monitor, notebook, mobile phone, portable multimedia player, personal digital assistant (PDA), navigation system, etc.

The display apparatus 1 of FIG. 1 includes a signal receiver 11, a signal processor 12, a display unit 13, a user input unit 14, and a controller 15.

The signal receiver 11 receives an image signal from the outside. The image signal received by the signal receiver 11 may be a broadcasting signal, such as a DTV signal or a cable broadcasting signal. In this case, the signal receiver 11 tunes and receives a broadcasting signal of a channel selected according to the control of the controller 15. The channel may be selected by a user or by another method known in the art. Further, the image signal received by the signal receiver 11 may also be a signal output from a video device (not shown), such as a DVD player and a BD player. In addition, although not shown, the signal receiver 11 may receive a signal which includes an audio signal for audio output and a data signal for data output. The image signal, the audio signal, and the data signal may be received through a single signal.

The signal processor 12 conducts signal processing so that an image signal received by the signal receiver 11 is displayed on the display unit 13. the signal processing conducted by the signal processor 12 includes decoding, image enhancing, scaling, and the like. Furthermore, the signal processor 12 may conduct signal processing on the audio signal and the data signal received by the signal receiver 11.

The display unit 13 displays an image on the basis of the image signal processed by the signal processor 12. In addition, the display unit 13 displays information on data contained in the data signal processed by the signal processor 12.

The user input unit 14 receives input from a user and may be realized by a remote controller, an operation panel, etc, for example. The user's input received by the user input unit 14 is transmitted to the controller 15, and the controller 15 performs control based on the user's input. Alternatively, the controller 15 may receive input from another method such as by a computer, and performs control based thereupon.

The controller 15 controls components of the display apparatus 1 overall and includes software which is a control program and CPU and RAM to execute the software. For example, the controller 15 controls the signal receiver 11 to tune one of a plurality of channels of the broadcasting signal broadcasted by a broadcasting station (not shown), which is selected and controls the signal processor 12 to display an image based on the broadcasting signal received by the signal receiver 11.

Meanwhile, the display apparatus 1 may further include an audio output unit (not shown), e.g., a speaker, which outputs a sound based on an audio signal processed by the signal processor 12. Furthermore, the display apparatus 1 may also include a communication unit (not shown) which performs communication via a network, e.g., the Internet. The display apparatus 1 transmits or receives information to or from a counterpart communication device (not shown) using the communication unit. The information received from the counterpart communication device includes at least an image, sound and data, and the display apparatus 1 carries out a corresponding process to the information to be output through the display unit 13. In addition, the display apparatus 1 may further include a power supply unit (not shown) to supply power to the display unit 13, etc.

Hereinafter, the display apparatus 1 according to the exemplary embodiment will be explained in detail. The display apparatus 1 performs image adjustment to adjust the quality of an image displayed by the display apparatus 1 to be uniform. The image adjustment of the display apparatus 1 is carried out by an image quality adjustment unit 151. For example, the controller 15 may include the image quality adjustment unit 151.

Specifically, the image quality adjustment unit 151 includes an image quality adjustment program to carry out the image adjustment, a RAM (not shown) to load the image quality adjustment program, and a CPU (not shown) to execute the image quality adjustment program loaded on the RAM. The image quality adjustment program is stored in a nonvolatile memory (not shown), e.g., ROM or flash memory. The nonvolatile memory storing the image quality adjustment program may be provided either in the controller 15 or separately from the controller 15.

The display apparatus 1 may further include a main circuit board 20, e.g., PCB, and the CPU of the controller 15 including the image quality adjustment unit 151 may be provided in the main circuit board 20. Meanwhile, at least one of the signal receiver 11 and the signal processor 12 may include one or more integrated circuits, which may also be provided on the main circuit board 20. Furthermore, the signal receiver 11, the signal processor 12, and the controller 15 may be realized as a single integrated circuit.

The display unit 13, as shown in FIG. 1, includes a display panel 131 and a panel driving circuit 132. The display panel 131 is a display device displaying images and realized by a liquid crystal display (LCD), plasma display panel (PDP), and organic light emitting diode (OLED), for example. The panel driving circuit 132 drives the display panel 131 to display an image on the basis of an image signal input from the signal processor 12. The driving of the display panel 131 performed by the panel driving circuit 132 includes timing control. The panel driving circuit 132 may include a circuit board (not shown), e.g., a PCB, and at least one integrated circuit provided on the circuit board to drive the display panel 131.

The display unit 13 is connectable to another component of the display apparatus 1 (e.g., the main circuit board 20 having the CPU of the controller 15 with the image quality adjustment unit 151). For example, the display unit 13 may be manufactured separately from other components of the display apparatus 1, and the prepared display unit 13 may then be combined with another component of the display apparatus 1. Thus, the display apparatus 1 may further include a chassis (not shown) or a combining member (not shown) to combine the display unit 13 and another component. The display unit 13 may be provided in the form of a finished product.

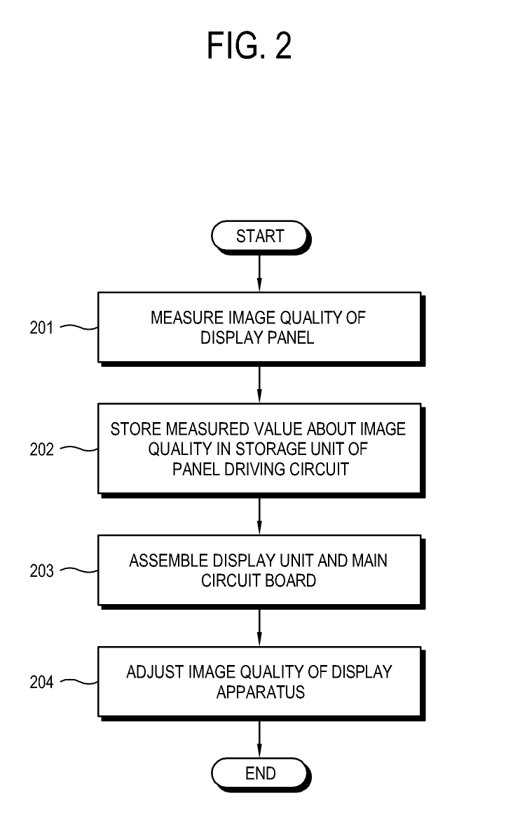

The display apparatus 1 according to an exemplary embodiment will be explained with reference to FIG. 2. FIG. 2 is a flow chart illustrating a process of adjusting image quality conducted by the display apparatus 1 according to the present exemplary embodiment.

As shown in FIG. 2, the image quality of the display panel 131, which was already manufactured, is measured (201). In the present exemplary embodiment, the image quality of the display panel 131 may be measured by a measurement device. The image quality measurement is carried out regarding various aspects, e.g., the color and/or the brightness of an image displayed on the display panel 131, depending on the purposes of the image quality adjustment.

When the measurement of the image quality for the display panel 131 is completed, the measured value is stored (202). The display unit 13 further includes a storage unit 133 which stores the measured values about the image quality of the display panel 131. The storage unit 133 is a nonvolatile memory, such as an EEPROM, and provided on the circuit board of the panel driving circuit 132.

Meanwhile, in addition to the display unit 13, although not shown, another component of the display apparatus 1, e.g., the main circuit board 20 having the CPU of the controller 15 with the image quality adjustment unit 151, may be manufactured separately from the display unit 13.

Returning to FIG. 2, the display unit 13, for which the measurement of the image quality was completed, is assembled with the main circuit board 20 having the CPU of the controller 15 with the image quality adjustment unit 151 (203). The assembly of the display 13 and the main circuit board 20 may be carried out in manufacturing the display apparatus 1 or in after-sales service.

Next, in the state of the display 13 being combined with the main circuit board 20, the image quality adjustment unit 151 adjusts the image quality of the display apparatus 1 (204).

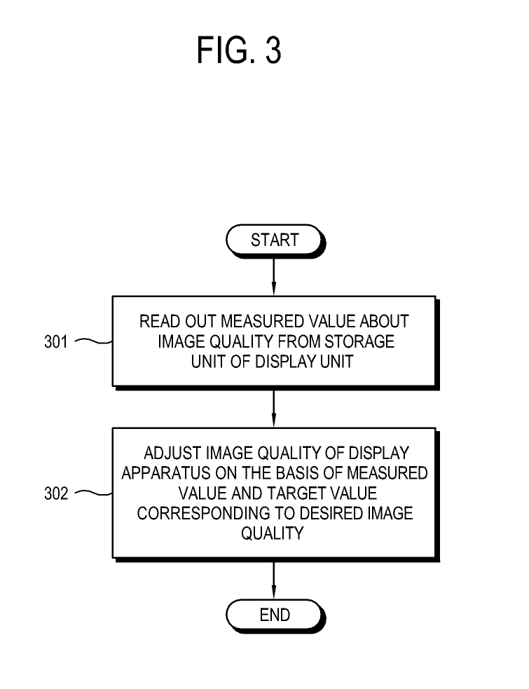

Hereinafter, the image quality adjustment of the display apparatus 1 according to an exemplary embodiment will be explained in detail with reference to FIG. 3. FIG. 3 is a flow chart illustrating image quality adjustment operations conducted by the display apparatus 1.

As shown in FIG. 3, the image quality adjustment unit 151 reads out the measured value or values about the image quality of the display panel 131 stored in the storage unit 133 of the panel driving circuit 132 of the display unit 13 (301). In this case, the measured values about the image quality may be stored at addresses of the storage unit 133, and the image quality adjustment unit 151 accesses the addresses to read out the measured value or values. The storage unit 133 may be an EEPROM, and the addresses may be predetermined. The image quality adjustment unit 151 has address information on the addresses of the storage unit 133, which stores the measured value or values about the image quality of the display panel 131, in a memory in advance and reads out the measured value or values with reference to the address information when adjusting the image quality.

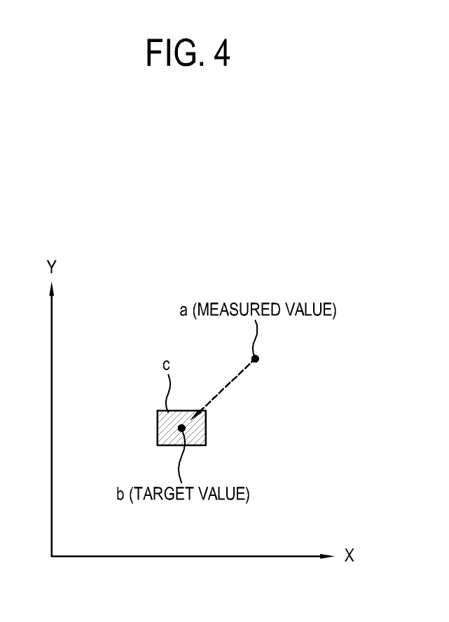

Next, the image quality adjustment unit 151 adjusts the image quality of the display apparatus 1 using the measured value read out from the storage unit 133 of the display unit 13 (302). The image quality adjustment unit 151 adjusts the image quality of the display apparatus 1 on the basis of the measured value read out from the storage unit 133 and a target value corresponding to the image quality to be desired. The image quality adjustment of the display apparatus 1 is explained with reference to FIG. 4.

FIG. 4 illustrates a color coordinate used for the image quality adjustment conducted by the display apparatus 1 according to an exemplary embodiment. In the color coordinate of FIG. 4, the horizontal axis (x) and the vertical axis (y) indicate an x coordinate and a y coordinate of a color, respectively. The x and y coordinates in FIG. 4 correspond to color values expressed in, for example, the CIE XYZ color space. Further, reference letters “a” and “b” represent a measured value about the image quality of the display panel 131 and a target value corresponding to the desired image quality of the display apparatus 1, respectively. The target value b is not limited to a fixed value, but may be varied within a range c, as shown in FIG. 4.

The image quality adjustment unit 151 adjusts an adjustment factor so that the measured value a read out from the storage unit 133 reaches the target value b. The adjustment factor used for the image quality adjustment is various depending on the purposes of the image quality adjustment and may be used to adjust, for example, RGB values including R gain, B gain, R offset, and B offset, etc. A setup value of the adjustment factor is stored in at least one register used by the CPU of the controller 15. The setup value of the adjustment factor stored in the at least one register is referred to in the image processing of the signal processor 12 to be reflected on RGB values of an image displayed on the display unit 13. The image quality adjustment unit 151 changes the setup value of the adjustment factor stored in the at least one register so that the measured value a reaches the target value b, thereby adjusting the image quality of the display apparatus 1. Accordingly, the quality of the image displayed on the display 13 becomes the desired image quality.

As described above, the display apparatus 1 according to the exemplary embodiment conducts the image quality adjustment using the measured value about the image quality stored in the display unit 13, which can be separately manufactured, to save time for the image quality measurement to adjust image quality in manufacturing the display apparatus 1 including the assembly of the display unit 13, thereby efficiently reducing manufacturing processes.

The display unit 13 and another component of the display apparatus 1 may be manufactured by one manufacturer and then assembled with each other to complete the display apparatus 1. Alternatively, the display unit 13 may be separately manufactured by one manufacturer and then assembled with other components by another manufacturer.

Further, exemplary embodiments can also be used to adjust the image quality when repairing or replacing the display unit 13 or the main circuit board 20 in after-sales service of the display apparatus 1. In this regard, since there is no need to prepare a measurement device for the image quality adjustment, the after-sales service of the display apparatus 1 is effectively achieved.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a signal processor that processes an image signal;
a display unit that displays an image based on the image signal processed by the signal processor;
a storage unit that stores a measured value representing an image quality of the display unit; and
an image quality adjustment unit which carries out image quality adjustment of the display unit based on the measured value stored in the storage unit and a preset target value corresponding to a desired image quality of the display unit.

2. The display apparatus according to claim 1, wherein the storage unit is disposed in the display unit.

3. The display apparatus according to claim 2, wherein the display unit comprises a display panel that displays the image, and a panel driving circuit that drives the display panel based on the image signal.

4. The display apparatus according to claim 3, further comprising a main circuit board, wherein the image quality adjustment unit comprises a CPU, which is provided in the main circuit board and executes a program to carry out the image quality adjustment of the display unit.

5. The display apparatus according to claim 1, wherein the image quality adjustment of the display unit comprises at least one of color adjustment and brightness adjustment of the image displayed by the display unit.

6. The display apparatus according to claim 1, further comprising a signal receiver that receives the image signal, wherein the image signal comprises a broadcasting signal.

7. A method of adjusting image quality of a display apparatus which displays an image based on an image signal, the method comprising:
reading out a measured value representing image quality from a storage unit of the display apparatus; and
carrying out image quality adjustment of the display apparatus based on the measured value and a preset target value corresponding to a desired image quality of the display apparatus.

8. The method according to claim 7, wherein the display apparatus comprises a display panel that displays the image and a panel driving circuit that drives the display panel based on the image signal.

9. The method according to claim 8, wherein the display apparatus further comprises a main circuit board on which a CPU is provided, and carrying out the image quality adjustment comprises executing a program using the CPU.

10. The method according to claim 7, wherein carrying out the image quality adjustment comprises adjusting at least one of color and brightness of the image displayed by the display apparatus.

11. The method according to claim 7, wherein the image signal comprises a broadcasting signal.

12. A process of adjusting image quality during assembly of a display apparatus, the process comprising:
providing a display unit comprising a display panel and a storage unit;
measuring a value corresponding to the image quality of the display panel;
storing the measured value in the storage unit of the display unit;
combining the display unit with a main circuit board comprising a memory storing an image quality adjustment program; and
performing adjustment of the image quality based on the measured value stored in the storage unit of the display unit using the image quality adjustment program.

13. The process according to claim 12, wherein the memory on the main circuit board stores a target value, and
the image quality adjustment program adjusts the image quality based on the measured value and the target value.

14. The process according to claim 12, wherein the memory comprises a register which stores an adjustment factor for the image quality, and the image quality adjustment program adjusts the adjustment factor based on the measured value and the target value.

15. The process according to claim 12, wherein providing the display unit comprises manufacturing the display unit.

16. The process according to claim 12, wherein the providing the display unit comprises receiving a display unit for servicing.

17. The process according to claim 12, wherein:
the measured value of the image quality is stored in the storage unit at a preset address, and
the image quality adjustment program accesses the preset address to read out the measured value.

18. The process according to claim 12, wherein the image quality adjustment program is preprogrammed with the preset address of the storage unit from which to read the measured value.

19. A process for adjusting image quality of a display apparatus during manufacturing, the process comprising:
manufacturing a display panel comprising a storage;
measuring a value corresponding to the image quality of the display panel;
storing the measured value in the storage;
separately manufacturing a main circuit board comprising a controller storing an image quality adjustment program;
assembling the display panel and the main circuit board together into the display apparatus; and
adjusting the image quality of the display panel based on the measured value stored in the storage using the image quality adjustment program.
